(19) United States
(12) Patent Application Publication
(10) Pub. No.: US 2019/0228364 A1
(43) Pub. Date: Jul. 25, 2019

(54) System and method for assessing an organization's innovation strategy against potential or future industry scenarios, competitive scenarios, and technology scenarios

(71) Applicant: Vector Analytics, Inc., Charlotte, NC (US)

(72) Inventors: Marcia L. Price, Charlotte, NC (US); Wlodek W. Zadrozny, Charlotte, NC (US)

(21) Appl. No.: 16/253,300

(22) Filed: Jan. 22, 2019

Related U.S. Application Data
(60) Provisional application No. 62/620,978, filed on Jan. 23, 2018.

(51) Int. Cl. G06Q 10/06; G06N 20/00

(52) U.S. Cl. CPC G06Q 10/06393; G06N 20/00; G06Q 10/067

(57) ABSTRACT

This invention defines a method and system for benchmarking an entity's innovation or research and development strategy (represented by a collection of documents) against a collection of documents or corpus that defines the future direction of an industry sector; a future technology or research and development roadmap; or the innovation strategy or research and development strategy of another entity; where an entity could be a corporation, a government, a country, an industry sector, a competitor, or a projected technology future scenario.

This invention identifies and uses implicit technology concepts to benchmark the innovation strategy or research and development strategy of one entity to a future technology roadmap or to the innovation strategy of another entity. These implicit technology concepts are used to build relationship data tables that define the links between entities, identify the overlaps and gaps between entities, and benchmark multiple entities.

### CROSS-REFERENCE TO RELATED APPLICATIONS

The present application claims priority to and the benefit of the filing data of U.S. Provisional Patent Application No. 62/620,978 entitled “A system and method for assessing an organization's innovation strategy against potential future industry and future technology scenarios” and filed on Jan. 23, 2018, the entire disclosure of which is hereby incorporated by reference for all purposes.

### BACKGROUND OF THE INVENTION

Benchmarking or conducting competitive analysis is a common objective of corporations, not-for-profit organizations, and government agencies. Conducting these analyses on innovation and/or research and development strategies is currently limited to patent analysis, citation/author analysis, and time consuming subjective analysis by subject matter experts. It often relies on keyword or phrase searches.

This invention provides an advantage over current solutions, as it benchmarks an entity's innovation strategy against another entity, a definition of a future market, industry sector, or technology corpus by identifying enabling implicit technologies and finding a gap or relationship in implicit technologies between the two entities under study, where an entity could be a corporation, a government, a country, an industry sector, or a projected technology future scenario. Current solutions only benchmark an entity's innovation strategy against another entity's innovation strategy using keywords or semantically similar words or short phrases. Current solutions do not identify the enabling, implicit technologies required to achieve an innovation strategy.

### BRIEF SUMMARY OF THE INVENTION

This invention defines a method and system for benchmarking an entity's innovation or research and development strategy (represented by a collection of documents such as a patent portfolio or an entity's descriptions of internal research and development activities) against a collection of documents or corpus that defines the future direction of an industry sector; a future technology or research and development roadmap; or the innovation strategy or research and development strategy of another entity, competitor, corporation, organization, country, or nation/state.

This invention identifies and uses implicit technology concepts to benchmark the innovation strategy or research and development strategy of one entity to a future technology roadmap or to the innovation strategy of another entity. These implicit technology concepts are used to build relationship data tables that define the links, identify the overlaps and gaps, and benchmark multiple entities; where an entity could be a corporation, a government, a country, an industry sector, or a projected technology future scenario.

### BRIEF DESCRIPTION OF THE DRAWING

FIG. 1 depicts a flowchart diagram of one embodiment of the system to assess an entity's innovation strategy against a potential future industry, against a future technology scenario, or against another entity's innovation strategy.

### DETAILED DESCRIPTION

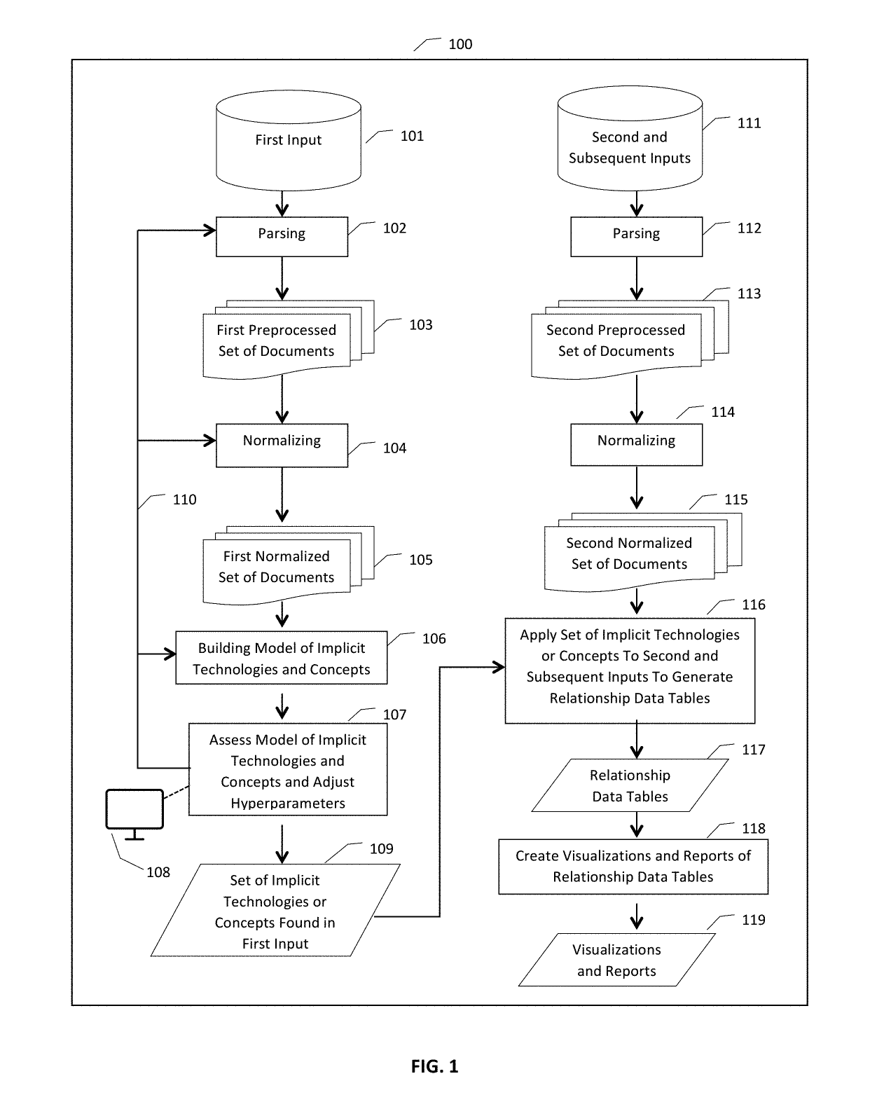

It will be readily understood that the components of the embodiments as generally described herein and illustrated in the appended FIG. 1 could be arranged and designed in a wide variety of different configurations. Thus, the following more detailed description of various embodiments is not intended to limit the scope of the present disclosures, but is merely representative of various embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes, which come within the meaning and range of equivalency of the claims, are to be embraced within their scope.

FIG. 1 depicts a flowchart diagram of one embodiment of a system 100 to benchmark innovation. In this embodiment, First Input 101 is a set of research and development budget documents that describe the future years research and development investment plan of a United States government department or agency as the First Input. This embodiment may utilize a set of United States companies' and/or foreign country companies' patent portfolios as the Second Input 111. The methods 102 and 112 of parsing and converting the documents of the First Input 101 and the Second Input 111 into appropriate textual representation may be a PDF (Portable Document Format) to text conversion computer software package, extraction of elements from XML documents, building ontologies or other formal and conceptual representations, or parsing algorithms written in any programming language. The method of normalizing the First Preprocessed Set of Documents 103 and the Second Preprocessed Set of Documents 113 may be written in any programming language and may include use of regular expressions to manipulate text, lemmatization, stemming, use of stop words, methods of tokenization, and other text normalization techniques to create the First Normalized Set of Documents 105 and the Second Normalized Set of Documents 115. The method 106 of building a model to generate implicit technologies or knowledge representations may be building a word embedding, concept embedding, or other embedding based computer software package or machine learning model; a topic model or machine learning model based on neural networks, latent Dirichlet allocation, or other machine learning or reinforcement learning technology; or other methods for unsupervised classification of documents that may result in a machine learning model that learns implicit technology concepts by developing word-topic probabilities or weights and topic-document probabilities or weights or similar statistics. A set of model performance measures and diagnostics statistics is used to assess the model of implicit technologies or concepts and adjust model hyperparameters, preprocessing hyperparameters, and normalization hyperparameters 107. A feedback loop 110 between the model performance measures and diagnostics statistics 107 and earlier steps 102, 104, and 106 in the flowchart is provided. A computer display 108 will be used to allow user interaction with the assessment of the model and adjusting of hyperparameters 107. The model 106 will be used to generate an optimized set of 109 implicit technologies or knowledge representations found in the First Input 101. The method 116 for identifying an overlap and other relationships between the processed representations of the First Input 101 and the processed representations of the Second and Subsequent Inputs 111 may be a topic model, a text clustering machine learning model, a machine learning model that otherwise compares an overlap between the processed representations, or some method of measuring document and corpus similarity. The results of procedure 116 for comparing an overlap or relationship between the First Input 101 and the Second Input 111 will be relationship data tables 117. A method 118 for creating visualizations and reports of the relationship data tables will result in a set of visualizations and reports 119 for display or reporting purposes. The result of the said procedure 116 may produce other types of information such as the provenance of the elements of the relationship data tables.

In another embodiment of a system 100 First Input 101 is a set of research and development budget documents that describe the future years research and development investment plan of the United States government department or agency as the First Input. This embodiment may utilize a set of United States government awarded contracts as the Second Input 111.

In another embodiment of a system 100 First Input 101 is a set of research and development budget documents that describe the future years research and development investment plan of the United States government department or agency. This embodiment may utilize a set of research and development plans of a foreign nation, foreign country, or nation-state as the Second Input 111.

In another embodiment of a system 100 First Input 101 is a set of documents that describe the future direction or technology roadmap of an industry segment or market. This embodiment may utilize a set of documents that describe the future or current innovation activities of a specific entity as the Second Input 111.

In another embodiment of a system 100 First Input 101 is a set of documents that describe the future or current innovation activities of a specific entity. This embodiment may utilize a set of documents that describe the future or current innovation activities of a competitive or different specific entity as the Second Input 111.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product, comprising:
a non-transitory computer readable storage medium to store a computer readable program, wherein the computer readable program, when executed by a processor within a computer, causes the computer to perform a method for generating an assessment of an organization's innovation strategy, the method comprising:
parsing a first input set of documents into a first preprocessed set of documents;
normalizing the said first preprocessed set of documents into a first normalized set of documents;
building the model of implicit technologies and concepts, and generating a set of implicit technologies and concepts;
adjusting the hyperparameters of the said model, of the said normalized set of documents, and/or the said preprocessed set of documents to optimize the model of implicit technologies and concepts;
optionally repeating the said steps of preprocessing, normalizing and building;
parsing a second input set of documents into a second preprocessed set of documents;
normalizing the said second preprocessed set of documents into a second normalized set of documents;
applying the said set of implicit technologies and concepts to the said second normalized set of documents, and generating relationship data tables describing the presence of said implicit technologies and concepts in the said second normalized set of documents.

2. A computer program product of claim 1, further comprising:
a user interface where the said user may adjust the hyperparameters of the said implicit technology model, the said hyperparameters of normalizing, and the said hyperparameters of preprocessing.

3. A computer program product of claim 1, wherein the said parsing step of converting and parsing the input corpora into appropriate textual representation further comprises:
one or more of a Portable Document Format (PDF) to text conversion computer software package, extraction of elements from XML documents, building ontologies or other formal and conceptual representations, or parsing algorithms written in any programming language.

4. A computer program product of claim 1, wherein the said normalizing step further comprises:
one or more of steps of using regular expressions to manipulate text, lemmatization, stemming, use of stop words, methods of tokenization, and other text normalization techniques.

5. A computer program product of claim 1, wherein the said step of building model of implicit technologies and concepts further comprises:
one or more of the steps of applying a word embedding, concept embedding, or other embedding based computer software package or machine learning model; a topic model or machine learning model based on neural networks, latent Dirichlet allocation, or other machine learning or reinforcement learning technology; or other methods for unsupervised classification of documents that may result in a machine learning model that learns implicit technology concepts by developing word-topic probabilities or weights and topic-document probabilities or weights or similar statistics.

6. A computer program product of claim 1, wherein the said assessing model of implicit technologies step further comprises:
one or more steps of calculating model performance measures, calculating model diagnostic statistics, and allowing a user to interactively review these measures and statistics and rate the quality of implicit technology topics and concepts by allowing the user to review the model output weights and probabilities and other topic characteristics.

7. A computer program product of claim 1, wherein the said step of applying the set of implicit technologies or concepts to the second and subsequent inputs and generating relationship data tables further comprises:
one or more steps of applying or inferring a topic model, a text clustering machine learning model, or a machine learning model that otherwise compares an overlap between the processed representations, or some method of measuring document and corpus similarity, and may produce other types of information such as the provenance of the elements of the relationship data tables.

8. A computer program product of claim 1, wherein the said creating of visualizations and reports of relationship data tables further comprises:
one or more steps of visualizing the said relationship data tables using diagrams, figures, and graphs; and
one or more steps of displaying the said relationship data tables using text or numerical data tables; and
one or more steps of providing the user with interactive exploration of the visualizations, text or numerical data tables, and the provenance of the elements of the visualizations and text or numerical data tables.

9. A system for assessing an organization's innovation strategy against potential future industry and technology scenarios comprising:
a memory device; and
a hardware processor (CPU or GPU) in communication with an input device, an output device, and a visualization module, configured to:
receive or import a first collection of documents (First Input);
receive or import a second or subsequent collection of documents (Second Input);
parse, preprocess, and normalize the documents of the First Input and the Second and Subsequent Inputs into appropriate textual and knowledge representations;
execute on the said CPU or GPU a collection of one or more computer programs for building a model to discover implicit technologies and concepts found in the First Input;
execute on the said CPU or GPU a collection of one or more computer programs for applying the set of implicit technologies or concepts and comparing an overlap and other relationships between the processed representations of the First Input and Second and Subsequent Inputs;
execute on the said CPU or GPU an interactive model assessment and refinement process;
execute on the said CPU or GPU a collection of one or more computer programs for visualizing system results and allowing a user to interactively explore system results in the form of figures, diagrams, graphs, text data tables, and numerical data tables.
